(19) United States
(12) Patent Application Publication
(10) Pub. No.: US 2007/0256124 A1
(43) Pub. Date: Nov. 1, 2007

(54) Collectible token data management

(75) Inventors: Ronald H. Ih, Los Altos, CA (US); William T. Sumerlin JR., Pleasanton, CA (US); James Douglas Seelig, Topanga, CA (US)

Correspondence Address: Kokka & Hsu, PC, Suite 250, 1001 N. Rengstorff Ave., Mountain View, CA, 94043-1748, US

(73) Assignee: Go Play Network, Inc., Los Altos, CA (US)

(21) Appl. No.: 11/404,962

(22) Filed: Apr. 13, 2006

(51) Int. Cl. H04L 9/32

(52) U.S. Cl. 726/9

(57) ABSTRACT

Collectible token data management is described, including creating a visual representation of a token, associating a data structure and data with the token, and transmitting at least a portion of the data to a receiver in response to a user input with the token.

### FIELD OF THE INVENTION

The present invention relates to software architecture, and, more specifically, to collectible token data management.

### BACKGROUND

Collectibles are items created to be purchased and collected by consumers. A consumer may choose to collect an item based on their interest in a subject matter of the item or in the item itself. Collectibles may have a certain perceived value, which may be much higher than their actual value, based on the subject matter, condition, appearance, and rarity of the item. A wide variety of collectibles are available. Some types of collectibles include trading cards (including sports cards, such as baseball and football cards), figurines, and coins.

Trading cards and other collectibles (e.g., sports cards) are collected by sports and collectible enthusiasts who wish to collect cards of and related to their favorite athletes or other interests. Trading cards are typically printed on cardboard and include an image on the front and text on the back. The image may be of the subject matter of the card (e.g., a picture of an athlete), and the text may include statistics related to the subject matter of the card (e.g., the athlete's statistics).

Trading cards and other collectibles have several drawbacks. First, the value of a trading card or collectible is heavily dependent on the physical condition of the card or collectible. Minor flaws may dramatically reduce the value of the card. Second, trading cards and other collectibles may be difficult and expensive to store. A large collection can occupy a substantial amount of space and damage can easily occur due to environmental factors (e.g., rain, snow, temperature changes, and the like) and improper storage. Third, trading cards and other collectibles have limited utility beyond presenting static information. Conventionally, trading cards and other collectibles offer pictures, statistics, and other static information (i.e., subject matter) based on physical condition and appearance, but offer no additional features or functionality.

Thus, what is needed is a collectible without the limitations of conventional techniques.

### BRIEF DESCRIPTION OF THE DRAWINGS

The present invention will be readily understood by the following detailed description in conjunction with the accompanying drawings, and like reference numerals designate like structural elements.

FIG. 1A illustrates an exemplary pack of tokens;

FIG. 1B illustrates an exemplary data structure for storing information that may be associated with a token;

FIG. 2A illustrates an exemplary system for storing and using tokens;

FIG. 2B illustrates exemplary data structures associated with a set of tokens;

FIG. 2C illustrates an exemplary block diagram for a collectible token system;

FIG. 3A illustrates exemplary functionality in a game using tokens;

FIG. 3B illustrates an exemplary trading system for tokens;

FIG. 4A is a flowchart illustrating an exemplary process for creating and using a token;

FIG. 4B is a flowchart illustrating an exemplary process for transferring tokens between owners;

FIG. 4C is a flowchart illustrating an exemplary process for establishing an account;

FIG. 4D is a flowchart illustrating an exemplary process for creating a child token;

FIG. 5A is a block diagram illustrating an exemplary computer system suitable for implementing a collectible token system; and

FIG. 5B is a block diagram of an exemplary portable device.

### DETAILED DESCRIPTION

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described examples may be implemented according to the claims without some or all of these specific details. For the purpose of clarity, technical material that is known in the technical fields related to the examples has not been described in detail to avoid unnecessarily obscuring the description.

In some examples, a token may be a virtual container and a key. The token may have a visual representation that indicates the subject matter of the contents of the token. In other examples, tokens may be used in a game, a trading platform, or as currency used in both real-world (i.e., physical environment where a token may be used to effect a transaction (e.g., purchase full or discounted tickets or get free tickets to an event, trade, buy other tokens, and others) and virtual settings (e.g., virtual communities, games, and the like). One or more data structures may be used to implement a token, which contains data and content of various types, such as videos, images, or text files, may be associated with the token. The token may be accessed using a receiver such as a cellular telephone, personal digital assistant (PDA), or a personal computer (PC) or other processing system. Tokens and associated data and content may be accessed using a network and transmitted to a receiver in response to a user input associated with the token.

An Exemplary Pack of Tokens

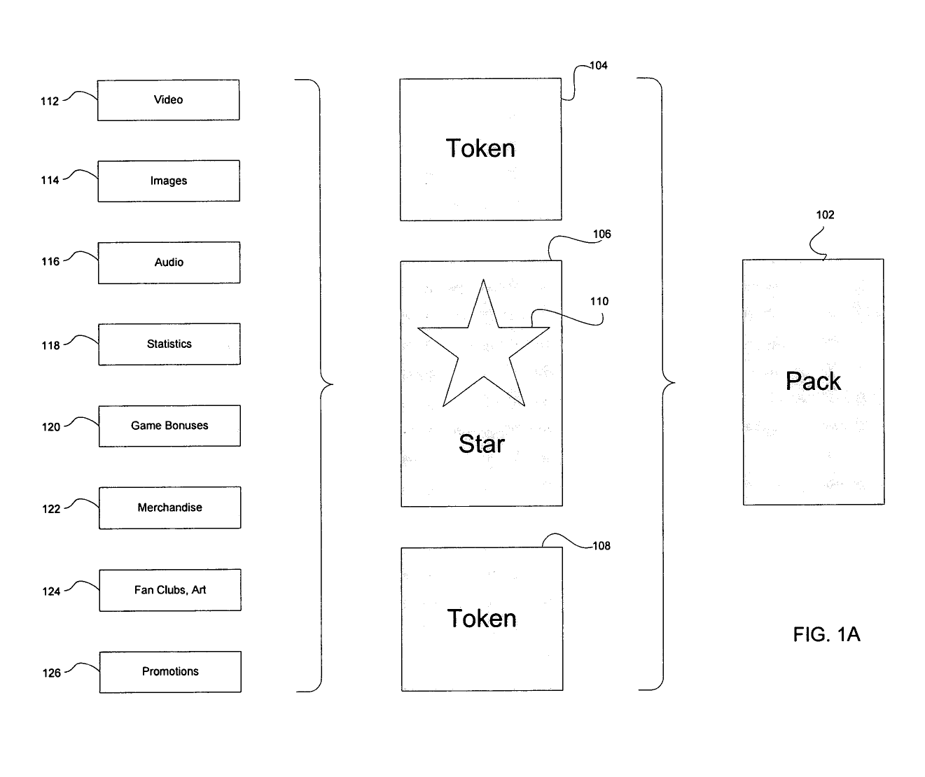

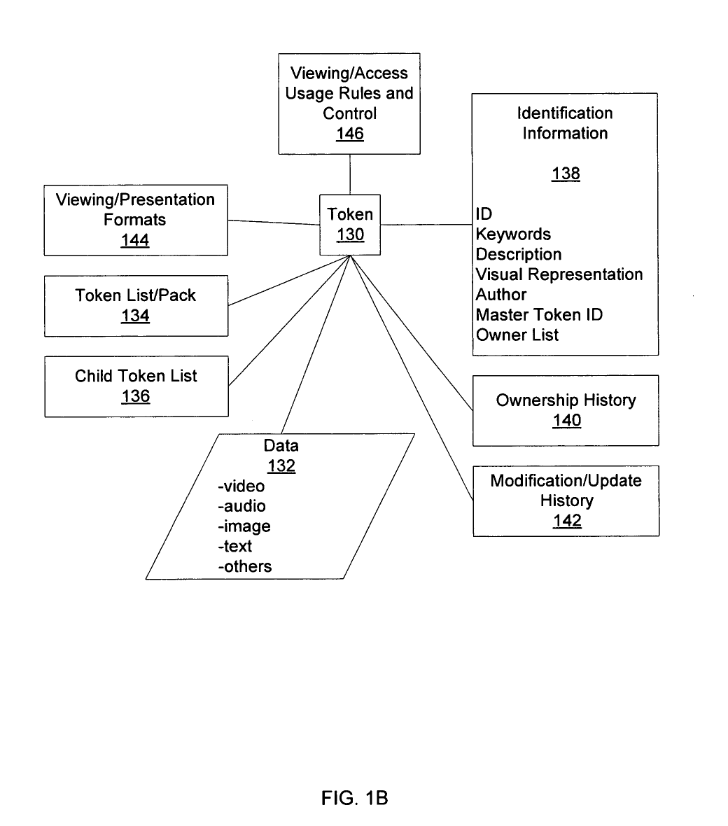

FIG. 1A illustrates an exemplary pack of tokens. A pack 102 may include three tokens 104, 106, and 108. A token is a virtual (i.e., online, non-physical, but programmed or system-computed) object that includes a container for storing references to data structures and data and a key that can be used to access various outside resources related to the token. As an example, an outside resource (“resource” or “service”) may be a service, application, or other system that is referenced by a token, which may be directly associated with it. A token may access a physical access system (i.e., resource) that allows a user to sit in a given seat in a ball park, auditorium, or other venue. Alternatively, a resource may be a system, service, or mechanism that provides direct access or control of one or more tokens to a bank account, safe deposit box, or other secure location, information, or associated physical objects. In still other examples, resources may be implemented differently. Here, a token may include a visual representation that indicates the subject matter of the contents of the token. For example, the token 106 includes a visual representation 110 of a star along with a name of the token. Other visual representations may include, for example, pictures and names of athletes, sports teams, and other figures. In some examples, tokens may be accessed using a client (i.e., computer program or application (“application”)) on a receiver such as a cellular telephone or personal computer.

Tokens may be used to categorize interests of a user or owner (“owner”). For example, an owner may collect tokens of baseball players in which the owner is interested. The tokens may include references to information and media (e.g., statistics about a baseball, basketball, football, soccer, or other athletic player). Tokens may include content about various subjects including, but not limited to, athletic and sporting-related topics and games, geographical locations, political events and personae, industry or business-related themes and personalities, celebrities, virtual characters (i.e., avatars, and the like), and others. Tokens may be used with other types of interests and the examples provided and described herein are not limiting. Thus, the owner can easily collect and categorize information and content about a specific subject in which the owner is interested.

Tokens may be distributed in the form of a pack, which includes one or more tokens, and can be purchased or otherwise transmitted to a user using techniques and systems that are explained below. The pack may include a random assortment of tokens chosen from a series, for example a random selection of baseball players if a pack of baseball tokens is purchased. Tokens may also be distributed in sets (e.g., an entire baseball team) or individually.

An owner may have an account with a system that manages the tokens. Tokens may be associated with the token owner's account. Tokens may be accessed by the owner over a network and stored on a server. An owner can log into their account and access their tokens using a receiver such as a cellular telephone or a personal computer.

Each token may have a subject matter to which the visual representation is related. Any type of subject matter may be represented by a token. For example, a token may represent an athlete, sports team, celebrity, automobile, historical landmark, or other information. A token may be created by an author who associates various data structures with the token, which may also be related to the subject matter of the token. For example, the token 106 is associated with a video 112, an image 114, an audio file 116, statistics 118, game bonuses 120, merchandise keys 122, fan art 124, and promotional keys 126. Other types of data or content may be associated, including streaming video, animation sequences, television shows, and others.

The data structures may include content related to the subject matter of the token. For example, the token 106 may be a token for a baseball player. The video 112 may be a video of the player hitting a home run, the image 114 may be a picture of the player, and the statistics 118 may be real-time updated statistics for the player's current season. An owner who possesses the token 106 may also add their own content. For example, an owner can add pictures of the player or text about the player, to customize the token 106.

The merchandise keys 122 and promotional keys 126 are examples of types of keys that may be associated with the token 106. Keys allow a user to use the token to access various outside resources, such as a promotion at a baseball game or access to a restricted website. For example, a user can access a token using their cellular telephone, which can transmit an access code to a terminal at a baseball game to verify that certain merchandise is available to the owner. The token is therefore used as a key to obtain this merchandise. As another example, discounted tickets may be types of promotions that allow a token owner to purchase event tickets to a real-world event at a discounted price. Event tickets may be merchandise or promotions and may also be purchased for a price, exchanged for a token, and the like. As an outside resource, an electronic access or verification system may be accessed when promotional key 126 is used to enable a user to access a venue, forum, arena, or other physical location for a price. As yet another example, a user may access their token on the Internet using a computer, server, notebook or laptop computer, wireless computing device, personal digital assistant, or other processing system (i.e., computer), and use that token to access restricted areas of websites or other services.

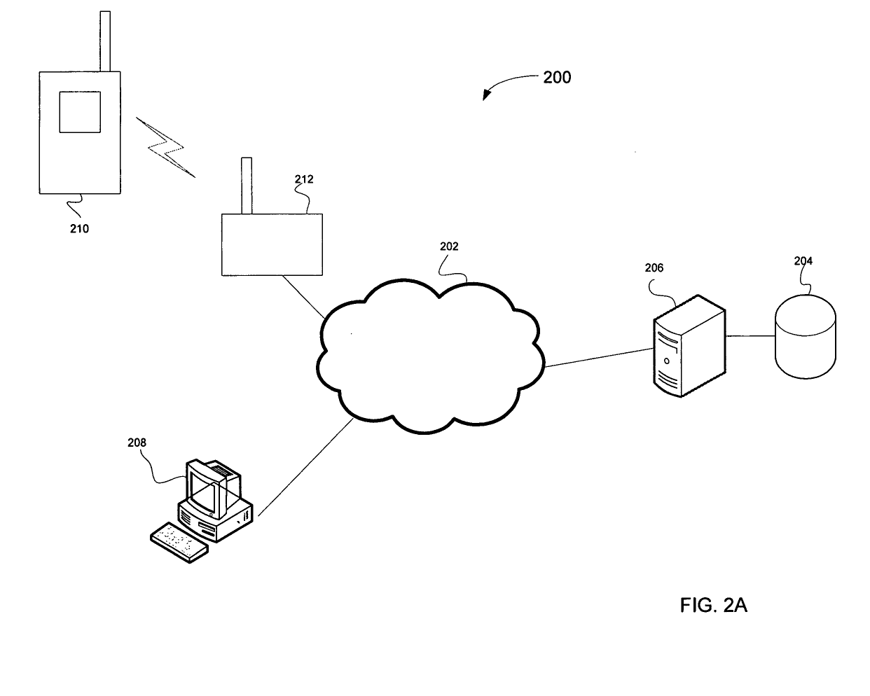

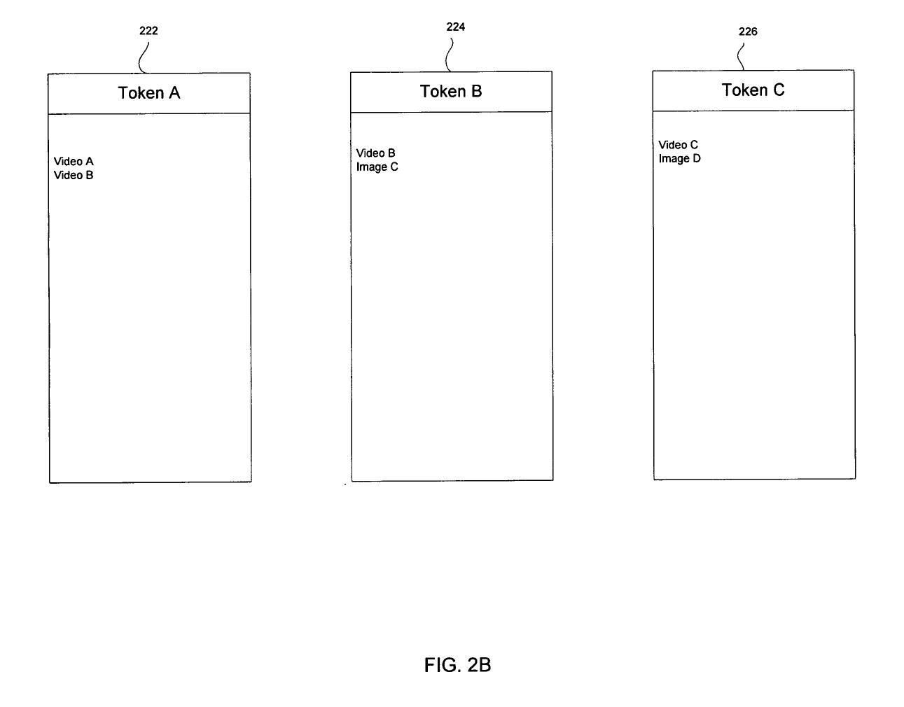

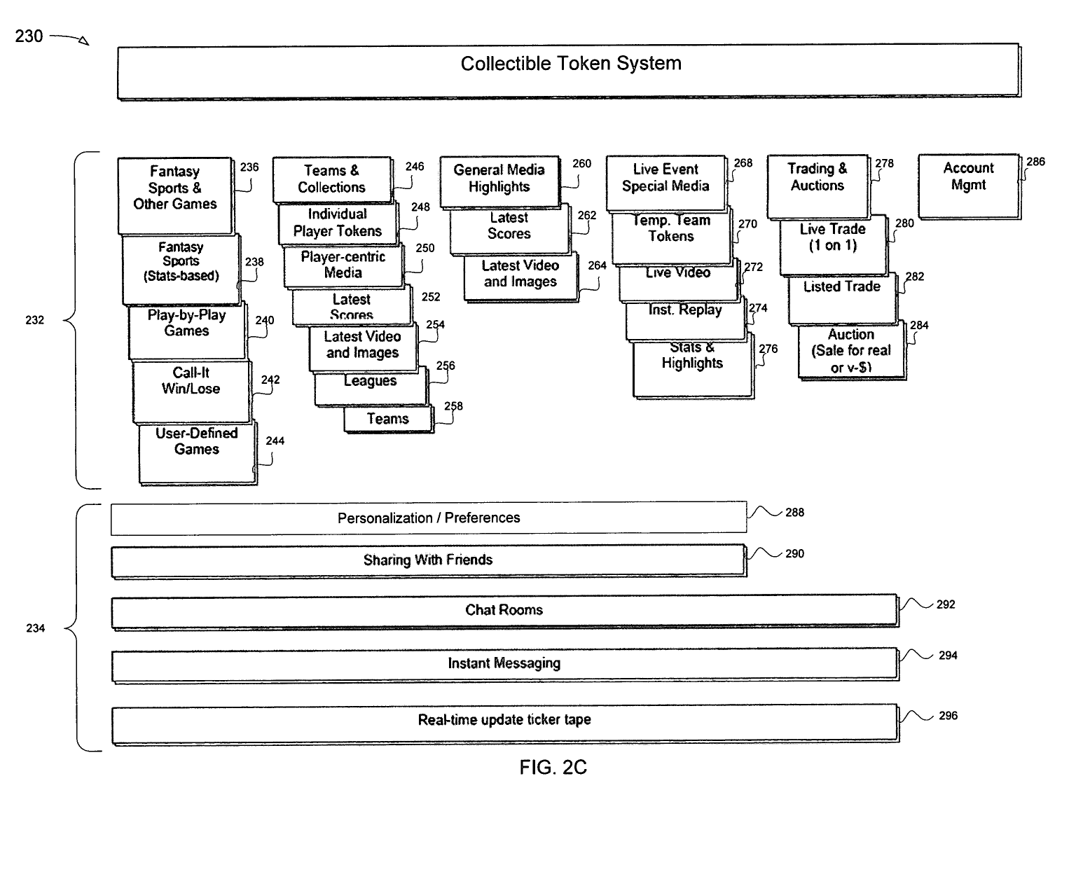

In some examples, data associated with tokens may also be enhanced or updated. For example, an author of the token 106 may want to add an additional video or image to the token 106. The author (e.g., owner) associates the token 106 with the new video or image (see, e.g., FIG. 2B). The owner of the token 106 can then view the new video. Additionally, an author or other party can update data already associated with a token. For example, the statistics 118 can be updated as new data becomes available. Updated and new data and data structures can also be pushed to the owner's token when updates become available. The owner may also add their own content to the token 106.

In some examples, tokens may also have a value that can be influenced by several factors. Factors may include availability of a token's content, the nature of the token's subject material, the quality and currency of the token's data, and the amount and quality of token's artwork. For example, a token of a superstar baseball player is likely to be more desirable than a token of a lesser player. The supply of tokens can be managed by the token's authors or publishers to increase the value of certain tokens. For example, an author or publisher can issue relatively few of a certain token to increase the value of that token. Tokens with individualized, additional content added by owners may also be more valuable than their unmodified counterparts.

FIG. 1B illustrates an exemplary data structure for storing information that may be associated with a token. Here, token 130 may include various types of data structures and data 132 (e.g., video, images, audio and other types of data, as well as space for pointers/references to data that may be stored externally to token 130 (e.g., a reference to a third party's web page and the like), including token lists or packs 134 (i.e., lists of identification numbers (“IDs”) for other tokens that are contained within token 130), child token list 136 (i.e., token IDs of other copies of token 130), identification information 138 (e.g., ID, keywords, description, visual representation, author, master token ID, owner list, and the like), ownership history 140, modification/update history 142 (e.g., updates and modifications made, authors of the updates and modifications, when updates and modifications are made, and the like), viewing/presentation formats 144 (i.e., fixed and dynamic information that controls how a token's information is displayed and transferred), and viewing/access usage rules and control parameters 146 (e.g., rules and controls that govern who/when/how a token may be viewed, updated, traded, sold, or given away, and the like). In other examples, more, fewer, or different types of data structures and data may be used apart from those shown and described. Token 130 is an example of an internal representation of a Token. Other representations may be used apart from the example shown. Token 130 may contain information that identifies and describes token 130 using words (i.e., text) and pictures (i.e., images, graphics, photos, and others) for token owners, guests (i.e., users allowed by an owner to view token 130).

System for Storing and Using Tokens

FIG. 2A illustrates an exemplary system for storing and using tokens. The system 200 operates over a network 202 which may be a wide area network (WAN) such as the Internet. According to some examples, tokens and associated data structures are stored in a volume 204 which is managed by a server 206. Management of tokens may be performed by a manager of the server 206, who may be an author of tokens and may also be a user of the server 206, a software routine, or some combination thereof. Certain aspects of managing tokens are described further in FIG. 2B. Although a manager of the server 206 is described herein, it is understood that the manager may manage other components of the system 200.

Various devices may be attached to the network 202. For example, a personal computer 208 may be directly connected to the network 202, and a portable (i.e., mobile, wireless communication, and the like) device 210 may be wirelessly connected to the network 202 through a transceiver 212. The portable device 210 may be, for example, a cellular telephone or a personal digital assistant. Various other devices may be attached to the network 202 to access the server 206. It is further understood that various protocols may be used to access and transmit data related to tokens over the network 202, and that the network 202 may be any type of network. For example, a local area network (LAN) may also be used to manage access to the tokens.

The volume 204 stores data structures and data (i.e., data and content of various types and formats including, but not limited to, videos, photos, and textual descriptions) associated with tokens. A data structure and various types of data may be associated with several different tokens. For example, when a token is authored, it may be associated with a video and pictures, and several copies of the token may be created from the original token. Each of these copies may be different, but associated with the same video or other data. It is understood that although a single volume 204 is shown that various other storage media including networked storage and storage spanning multiple volumes, servers, or networks may be used.

FIG. 2B illustrates exemplary data associated with a set of tokens. Here, each token is different from the other tokens. Although two different tokens may have the same content and functionality, each token can be modified by its owner and later transmitted to another owner. Owner modifications can increase the value of a token by, for example, adding content not available with other tokens. Subject matter (i.e., content, information, images, video, audio, or other data) may be, for example, information about a particular baseball player. Several copies of that token can be distributed by an author to various users. Each of those copies may be individually different, although the copies may have substantially similar content at the time of distribution or use.

An owner may be a user whose account is associated with a token. An owner may also be personally associated with a token (i.e., an owner may have a one-to-many relationship to many different tokens, but a given token may have a one-to-one relationship to a given owner, which may be an individual or a group entity). In some examples, a token may be temporarily or partially shared with other users, but a given individual owner controls the rights, access, and usage of the token. The user can also access tokens by signing into an account. In some examples, tokens may have additional security, whereby additional keys and passwords are used on an individual, encrypted token basis. The server 206 may be managed by a group that also creates tokens. When a token is created, the token is owned by the creator or by the group that the creator belongs. For example, a new token may be owned by a company until purchased and distributed to a customer (i.e., user). When a user purchases a token, either individually or in a pack, the token is then associated with the purchaser's account. The user can then access the token by signing into their account. Each token has a unique identifier which is associated with the token and its various data structures and data.

FIG. 2B illustrates exemplary set of tokens. Here, token A 222, token B 224, and token C 226 are shown. In some examples, various types of data (e.g., content) may be included. For example, within token A 222, video A and video B are included. Within token B 224, video B and image C are included. Likewise, within token C 226, video C and image D are included. Content (e.g., data or data elements) such as video A, video B, video C, image C, and image D may be types of data that are stored in or accessible by token A 222, token B 224, or token C 226. In other examples, different types of content and data may be included in token A 222, token B 224, and token C 226. In still other examples, more, fewer, or different tokens may also be included and are not limited to the examples described. For example, three videos are stored in a database on a server such as the volume 204. Each video is associated with a list of tokens. A video A is accessible by the tokens in a list 222, a video B is accessible by the tokens in a list 224, and a video C is accessible by the tokens in a list 226. Each of the lists 222, 224, and 226 may be associated with the various videos A, B, and C, and stored as the video's metadata or in some other database structure.

The example shown in FIG. 2B is exemplary and it is understood that various other techniques for associating data with data structures and tokens may be employed. For example, a central database may include a master list of tokens and the data and data structures associated with these tokens. Additionally, each token may include a list of data structures associated with it.

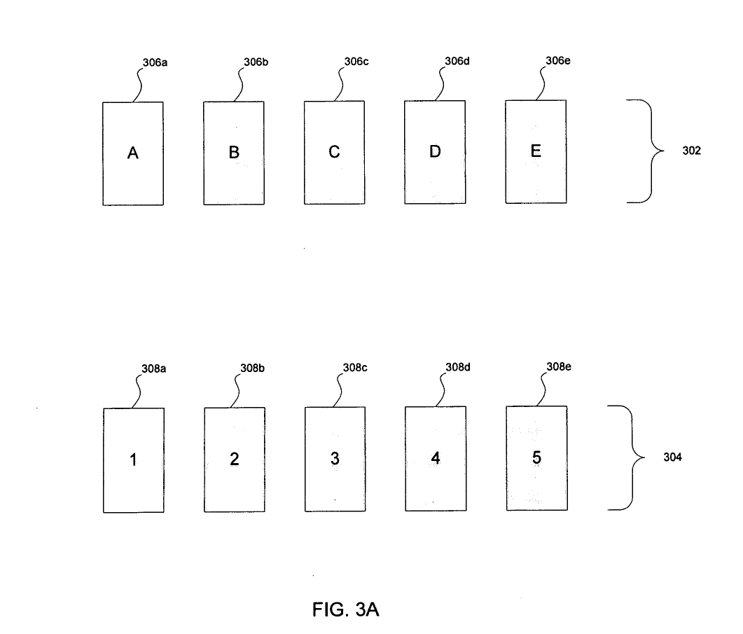

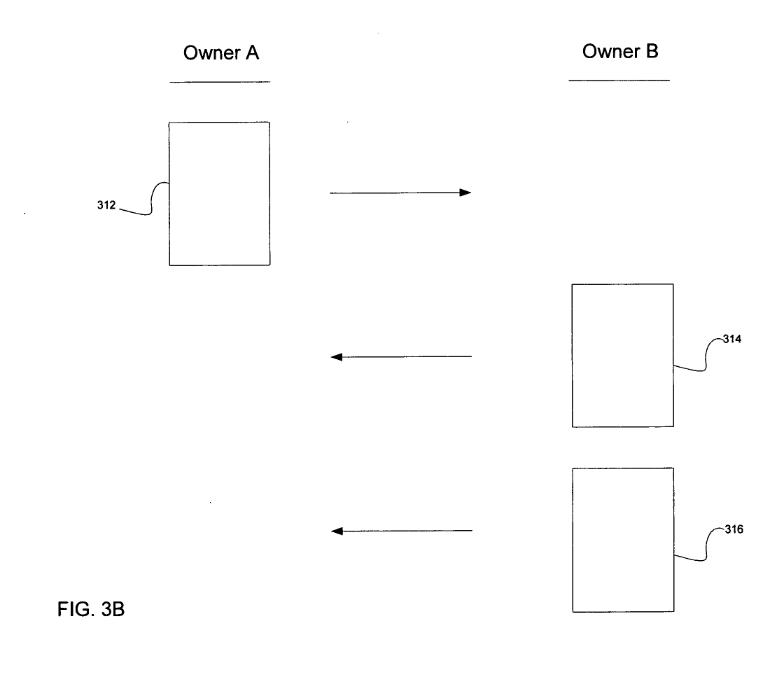

FIG. 2C illustrates a block diagram for a collectible token system according to an example. The token system 230 includes several functions and abilities. Although specific functionalities and features are described herein, it is understood that various other features may be realized using the token system 230. Certain of these features may be incorporated into an interface of a client used by an owner to access these features on a receiver. Some of these systems are explained in more detail below regarding FIGS. 3A and 3B.

In FIG. 2C, the token system 230 includes several items 232 that can be used with tokens and other items 234 that perform functionality related to the token system 230. The items 232 describe functionality that may be implemented using tokens (e.g., playing games with tokens). The items 234 can be used to enhance the experience of using the token system 230 by allowing an owner of tokens to communicate with other owners, for example.

Several functions may be performed using tokens. For example, tokens may be used for games, implemented as currency in a community (e.g., virtual or otherwise), coupled to reconciliation computers that, when coupled to banking systems, may be used to effect monetary exchanges, trades, purchases, or sales, and others. A token owner may use a token to play, for example, fantasy sports and other games 236, statistic-based fantasy sports 238, play-by-play games 240, call-it win/lose 242, and other types of games, including user-defined games 244. To play some of these games, the tokens may be used as gaming pieces. For example, tokens of baseball players can be arranged into teams to play team-based games.

Items 246-258 describe grouping tokens into various types of collections. Tokens may be organized into teams and collections 246, which may be organized by an owner assembling tokens (e.g., of individual athletes) into groups representing teams, leagues, or other organizations comprised of related tokens. Player tokens 248 may be individually issued for each player and may include associated data such as player-centric media 250, scores 252, and recent video and images 254. Tokens may also be arranged into leagues 256 such as fantasy leagues used to play fantasy sports and other games 236 and statistics-based fantasy sports 238. Individual tokens may also be issued for sports teams 258 and may also contain media, scores videos, and the like.

The token system 230 may also include general media highlights 260, which may be related to tokens in an owner's collection, and scores 262 and video and images 264 related to those highlights. In other examples, token system 230 may provide comprehensive information on a particular day for a particular sport as a token. Individual features may also be offered to an owner during special events. Live event special media 268 may be offered to an owner when such media is available, for example, during a baseball game. An event token (i.e., a type of token) may be purchased, which provides comprehensive information about a given event. For example, an event token may include a program guide, live event statistics, replays, video clips, and other information, features, or functionality related to the given event. In other examples, live event special media 268 may also describe other types of media beyond those described here. Temporary team tokens 270 can be offered to an owner during a baseball game so that the owner can access features associated with the temporary team tokens 270. The temporary team tokens 270 may include associated live video 272, instant replay 274, and statistics and highlights 276 of the sporting event.

The items 278-284 relate to exchanging tokens between owners, which is described in more detail in connection with FIG. 3B. An owner (i.e., user) may trade tokens using auctions 278, may perform live one-on-one trades 280, may list tokens available for trade on a message board 282 or classified service, or may sell or auction their tokens 284. Account management 286 allows an owner to manage, for example, his ‘Collectible System’ account.

The items 234 allow an owner or user to enhance their experience while using the token system 230. In some examples, system participants may use the token system 230 and its related services. However, some system participants (i.e., users) may not own a certain token and therefore cannot access all the services of token system 230 and functionality. An owner may personalize or change their preferences using a personalization/preferences panel 288. The owner may specify, for example, which aspects of tokens are most important to him. An owner may want to be presented with statistics when they first open a token. The owner may also specify whether they wish to be notified when new content is available. In other examples, an owner may specify other parameters or conditions that present other content when a token is opened.

An owner may establish a list of friends who also may use the token system 200. The sharing with friend's panel 290 allows an owner to share certain aspects of their tokens with friends. An owner can communicate with other users using chat rooms 292 and instant messaging 294. A real-time ticker tape 296 may be personalized by the owner and may present information to the owner about sports scores, stock quotes, news headlines and other content.

Using Tokens

FIGS. 3A and 3B illustrate various examples for using tokens. Several different uses for tokens are explained here. For example, tokens can be used to store and access data elements as discussed above, and can also be used to play games, such as fantasy team games, can be traded between owners, and can be used as a key for accessing promotions and other outside resources.

FIG. 3A illustrates exemplary functionality in a game using tokens. Here, two teams, a first team 302 and a second team 304, are shown in FIG. 3A. The first team 302 may be a basketball team, for example, comprising five tokens 306a, 306b, 306c, 306d, and 306e. Likewise, the second team 304 may comprise five tokens 308a, 308b, 308c, 308d, and 308e. Each of the tokens 306a-e and 308a-e has different basketball players as their subject matter. A user can substitute other tokens for the tokens 306a-e or 308a-e to make changes to their team as the season progresses, provided the substitutions involve basketball players and the substituted players meet the current league rules.

For example, tokens may be used to construct “fantasy” teams used in fantasy leagues. Fantasy sports are played by sports enthusiasts who assemble teams of various real-life athletes. The statistics of these athletes may be used to determine a game winner. In some examples, owners can group together tokens of athletes (i.e., tokens that are owned or accessible) into “teams” and use these teams to participate in fantasy games. A fantasy league may include a routine that can access and manipulate statistics (e.g., the statistics 118) associated with the tokens 306a-e and 308a-e. Thus, the fantasy league can be automated, using the statistics associated with the tokens 306a-e and 308a-e to determine updated scores and standings as new statistics become available. Results of a fantasy league may be reported to owners of teams as data associated with the tokens that comprise the teams or through other communication channels. In other examples, results may be reported differently and are not limited to those described herein.

FIG. 3B illustrates an exemplary trading system for tokens. Tokens may have a perceived or actual value. Tokens can be exchanged for other tokens or other consideration based on this perceived value. For example, an owner A owns a token 312, and an owner B owns tokens 314 and 316. The owner B wishes to trade the tokens 314 and 316 for the token 312. The token 312 has a higher perceived value to the owner B than either of the tokens 314 and 316. The perceived value of a token may be influenced by many factors including the subject matter of the token. For example, the token 312 may be a token of a superstar baseball player, while the tokens 314 and 316 are of lesser-known baseball players. Thus, the owners A and B would have perceived the value of the token 312 to be approximately equal to the combined value of the tokens 314 and 316. Alternatively, the token 312 may also have an enhanced value due to additional data such as media added to the token 312 by the owner A.

The exchange between owner A and owner B can be arranged using one of several different approaches. First, the owner A and the owner B may be acquaintances who arrange the trade themselves. In some examples, the owner A and the owner B can then instruct the manager of the server 206 to transfer ownership of the tokens to the other owner. This can be accomplished by changing the accounts associated with the tokens.

Alternatively, the owner A may find the owner B through some public, semi-public, or private medium. In some examples, public, semi-public and private communications and advertisements functionality may be included in token system 230 (FIG. 2C). For example, the owner A could advertise that the token 312 is available for trade on a website provided by server 206. If the owner A is a minor child, the owner A's parents may wish for the owner A to trade only amongst the owner A's friends. The owner A's parents could then establish a private group as part of the token system 230 on server 206 for trading between the owner A and the owner A's peers. The private group may also be administered by the manager of the server 206. In other examples, tokens may be bought, traded, sold, exchanged, or otherwise managed differently between individuals (e.g., owner A, owner B) and groups.

In some examples, tokens may be owned or collected by individuals or groups. Tokens may be used as containers (i.e., data structures) for information, data, content, and access authorization to services and provide motivation for the formation of groups around tokens of interest to individual groups. In groups, individuals can use tokens for various purposes including playing games, trading, communication, and other community-oriented functions. Within a group, a user may create a token. The owner (i.e., user) of that token may keep the token private and use it personally, temporarily share the token with other users in the group, or give, sell, or exchange with the other group members' copies of the original token. If the originally-created token is updated, any copy of the token may also be automatically updated, if appropriate authorization rules have been included in the copies. If the owner of a copy of the token adds or updates the copy, this information may be stored in the copy and no others. In some examples, an owner of a copy of a token may have authorization to effect changes beyond the copy, thus enabling updating of other tokens. In still other examples, updating may be performed differently. For example, with a shared master token, an owner or borrower of the master token may update data associated with the token and all copies of the token would be automatically updated.

Tokens may also be exchanged for other consideration or sold for cash. In some examples, tokens may be used to represent items for sale or barter. Tokens may be implemented with different qualitative (e.g., “good,” “better,” “best,” or the like) or quantitative (e.g., $10, $20, $50, and the like) values. Tokens may also be implemented using a value or rating system based on subjective factors for a particular type of subject matter. In some examples, an economic system may be established to use tokens as “currency” or a trading/exchange medium that users and owners may employ to purchase, sell, barter, exchange or trade in return for other tokens or goods and services. Tokens may also be used in varying contexts. In some examples, such an economic system may be referred to as a “virtual economy” that may be used to replace or supplement existing real-world economic systems. In other words, tokens may be used as currency in an online community, but also have real-world value (e.g., a token may be worth a given amount of money). For example, the token 312 may be advertised by the owner A on an auction-style or classifieds website (e.g., craigslist.com, realcities.com, and the like). Alternatively, tokens may be advertised on an internal community that is established for users and owners to purchase, sell, barter, exchange, or trade in return for other goods and services. The owner B could purchase the token 312 for cash, in exchange for which the owner A would transfer ownership of the token 312 to the owner B. Ownership changes, as described above, may be performed by the manager of the server 206, by associating the token with the new owner's account.

Processes for Using Tokens

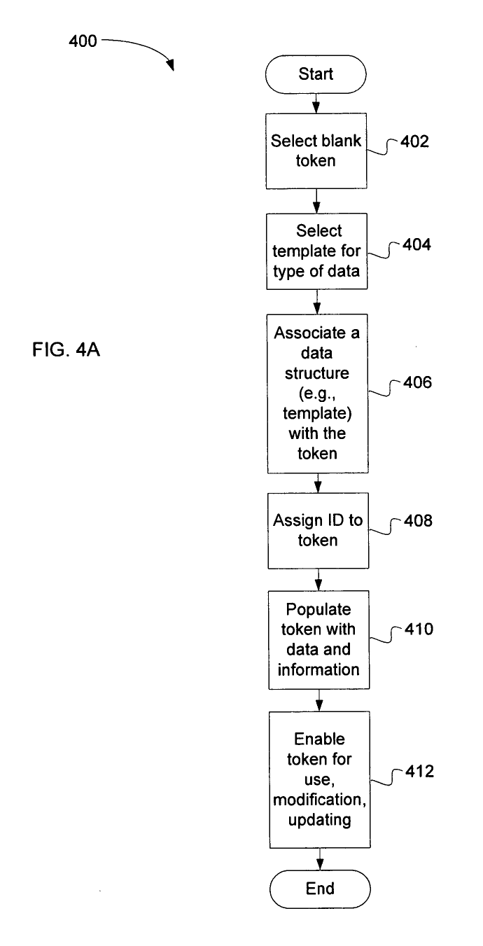

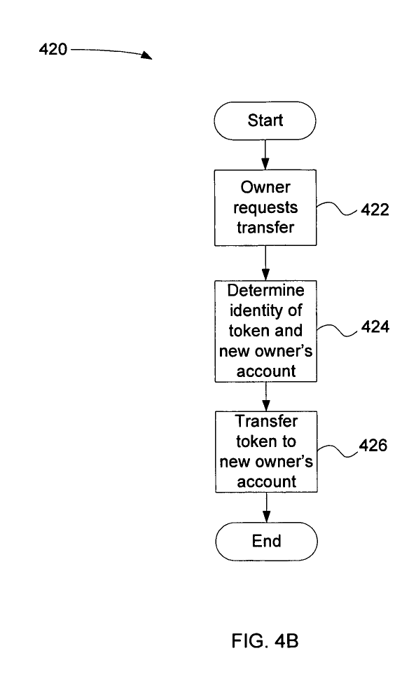

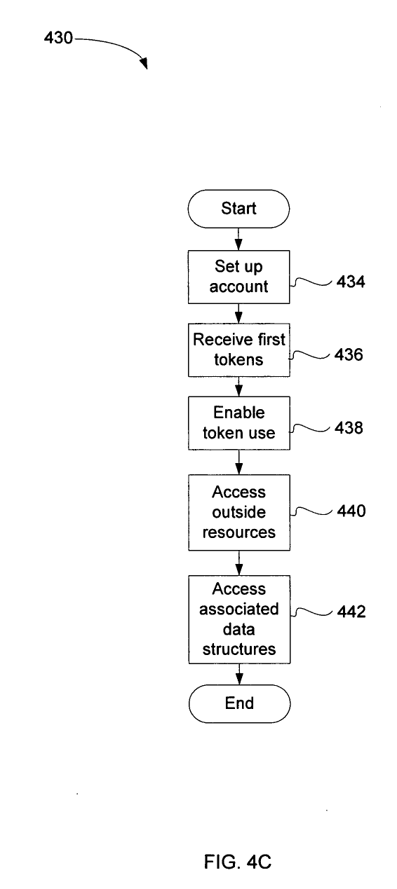

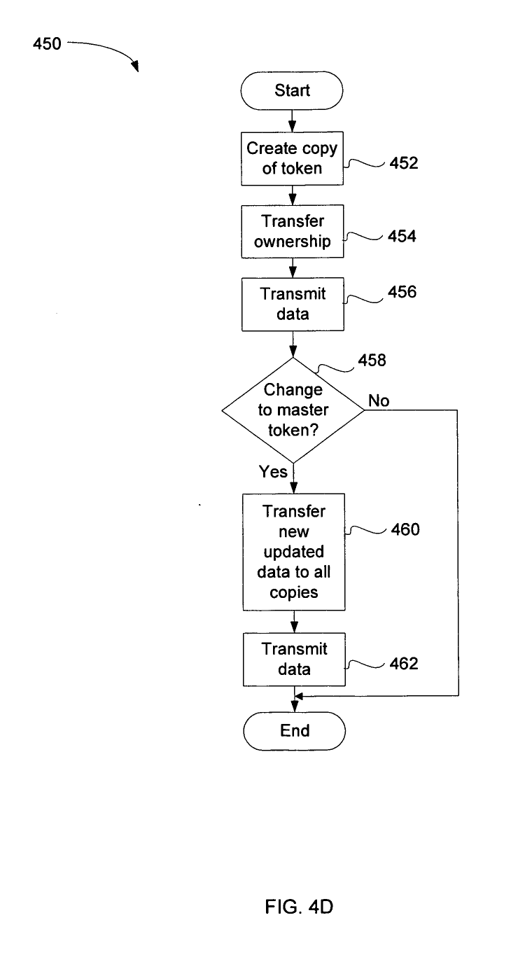

FIG. 4A is a flowchart illustrating an exemplary process for creating and using a token. Here, a user selects a blank token (402). Once selected, a template is also selected (i.e., manually or automatically) to identify the type of data to be stored in the token (404). A data structure for the selected template is associated with the token (406). The system (e.g., collectible token system 230 (FIG. 2C)) automatically assigns an ID to the token when the user obtained the blank token (408). The user may customize the token by populating a token with data and information (e.g., title, description, appearance, value, and the like) (410). In some examples, associating a data structure with a token may be different than populating a token with data information. For example, associating a data structure sets forth a data type and layout of information included in a token. In other examples, populating a token with data and information may be an optional sub-process. In still other examples, populating, updating, adding, or otherwise modifying data, content, and information in a token may be performed continuously, intermittently, or at other points before, during or after the creation of a token (e.g., a token may be exchanged, viewed, refreshed, and the like). Further, the user may add data content or define token usage and access rules during the creation process or afterwards (i.e., after a token has been initially created). A user (e.g., owner, token holder, purchaser, and the like) can then request access to the contents of the token, which are transmitted to the requesting user's receiver and viewer upon demand. In other examples, the above-described process may be varied in design, implementation, order of execution, and other characteristics, and is not limited to the descriptions provided.

FIG. 4B is a flowchart illustrating an exemplary process for transferring tokens between owners. The process 420 may be used with a system such as the system 200 to change ownership of a token in response to a transfer between two owners initiated because of a trade, sale, exchange, gift, or other type of transaction.

In block 422, the original owner of a token requests that the token be transferred to a new owner. The request may be received using the system 200. In block 424, an identity of the token and of the new owner's account is determined. The individual identity of the token and the owner's account are used in block 426 to affiliate the token with the new owner's account. The token may be transferred to the user account of the new owner in response to the user request of the original owner. According to an embodiment, the token's identity may be transferred to a list of tokens owned by the new owner.

FIG. 4C is a flowchart illustrating an exemplary process for establishing an account. The process 430 may be performed from a user's end with a receiver such as a cellular telephone or personal computer connected to a network. In some examples, a client may be downloaded or a web-based service may be accessed using a web browser. The client or web-based service provides functionality that allows a user to establish a token account. Here, a client may be a software program installed on the receiver. The client is used to access an owner's tokens and the functionality associated with those tokens. The owner can view data associated with the tokens, add data to tokens, play games using the tokens, and perform other functions (such as those described above regarding FIG. 2C) with the client. In other examples, downloading a client may be optional and, instead, a web-based service may be used to provide the functionality provided by the client. In other words, the described functions may be provided using a web browser instead of using an application. Browser extensions may be provided, including computer programs that are provided without the need for user intervention.

In block 434, the owner sets up an account using the client. Setting up the account may include choosing a screen name and a password. In block 436, the new user may receive a certain number of tokens as a sign up bonus or may be prompted to purchase some tokens for their account. For example, the user may receive two or three packs of tokens, which may be opened and accessed by the new owner. After receiving the first tokens, an owner or other user may use (e.g., view, play, arrange, trade, sell, exchange, use for purchase of other goods and services, and the like) the tokens, as shown in block 438.

Once the account is established, the owner can, for example, execute trades with other users in block 438, use tokens to access outside resources, as described above in block 440, or access associated data in block 442. Various other abilities of tokens have been described above. In other examples, the above-described process may be varied and is not limited to the examples provided.

FIG. 4D is a flowchart illustrating an exemplary process for creating a child token. Here, process 450 includes creating a copy of a token (452). Once created, the copied token is transferred to a new owner (i.e., an owner or user other than the owner of the master token) (454). Subsequently, data is transmitted to the copy (456). A check is made to determine whether a change to the master token has occurred (458), whenever the copied token is accessed. If a change has not occurred, then the process ends. However, if a change has occurred to the master token, then data is also sent and added to the copied token reflecting the changes (460). Once the newly updated data is transferred to all copies (460), the appropriate information is then transmitted (462) to the user making the original request. In some examples, transferring newly update data may be performed by transferring the data to accounts stored with the master token. The transfer updates the accounts for all copies and, subsequently, the updated account information is sent to all copies of the master token. In other examples, the above-described process may be designed, implemented, or performed differently and is not limited to the examples provided.

An Exemplary Computer System and Portable Device

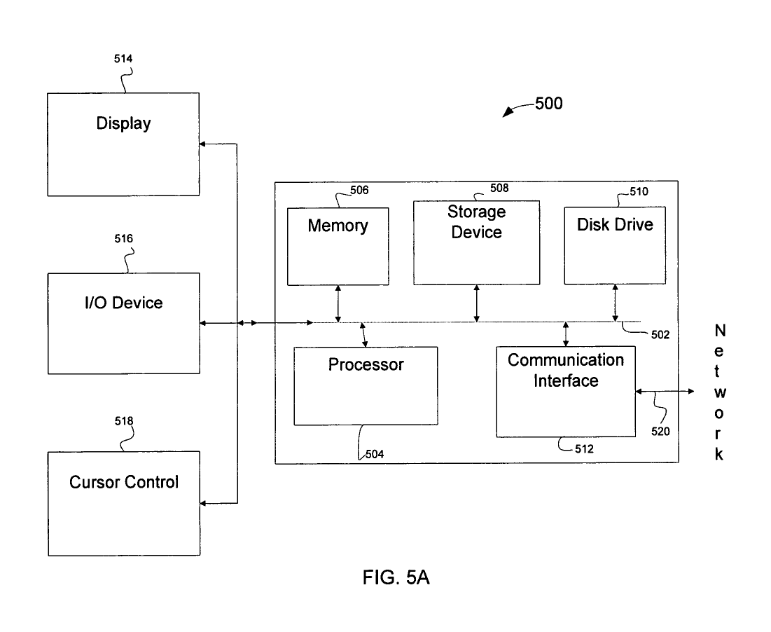

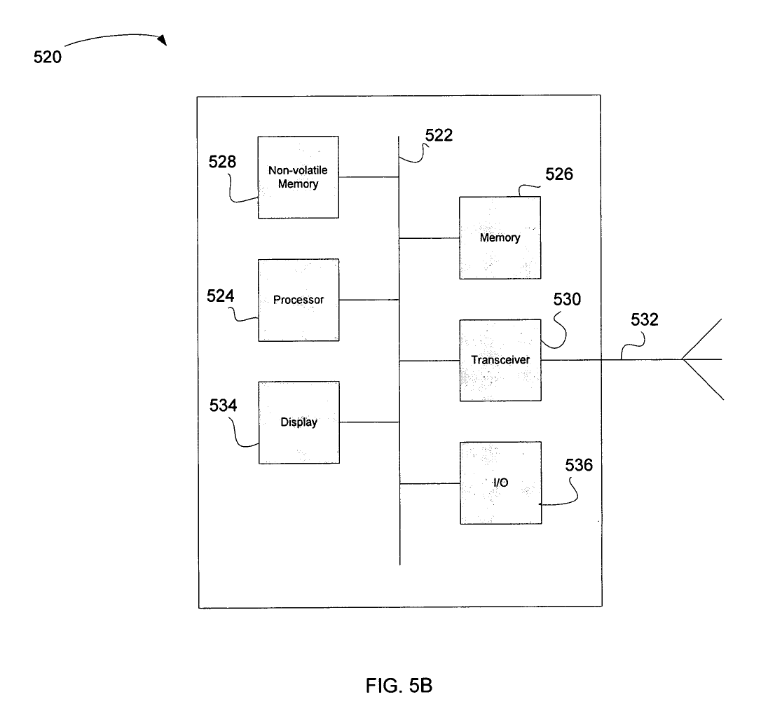

FIG. 5A is a block diagram illustrating an exemplary computer system suitable for implementing a collectible token system. In some examples, a computer system 500 may be used to implement computer programs, applications, methods, processes, or other software to perform the above-described techniques. The computer system 500 includes a bus 502 or other communication mechanism for communicating information, which interconnects subsystems and devices, such as a processor 504, a system memory 506 (e.g., RAM), a storage device 508 (e.g., ROM), a disk drive 510 (e.g., magnetic or optical), a communication interface 512 (e.g., modem or Ethernet card), a display 514 (e.g., CRT or LCD), an input device 516 (e.g., keyboard), and a cursor control 518 (e.g., mouse or trackball).

According to some examples, the computer system 500 performs specific operations by processor 504 executing one or more sequences of one or more instructions stored in the system memory 506. Such instructions may be read into the system memory 506 from another computer readable medium, such as the static storage device 508 or the disk drive 510. In some examples, hard-wired circuitry may be used in place of or in combination with software instructions to implement the invention.

FIG. 5B is a block diagram of an exemplary portable device. A portable device 520 may be, for example, a cellular telephone or a personal digital assistant (PDA). The portable device 520 can be used by an owner of tokens as a receiver to access their account, tokens, and associated data.

The portable device 520 includes several components that may be connected through a bus 522 which may be a single bus or a combination of busses. A processor 524 may be any type of appropriate microprocessor such as a microprocessor without interlocked pipeline stages (MIPS) processor

A memory 526 is connected to the bus 522 and may be a random access memory (RAM) such as a dynamic RAM (DRAM) or synchronous DRAM (SDRAM) for transient data storage. A non-volatile memory such as a flash memory 528 is also connected to the bus 522 and may be used for data storage. For example, the flash memory 528 may be used to store the client used to access the database and manage tokens.

The portable device 520 may also include a transceiver 530 and an antenna 532. The antenna 532 receives data packets transmitted, for example, from the transceiver 212 of the system 200. The portable device 520 may also include a display 534, which may be integrated and input/output (I/O) devices such as a keyboard or keypad, speaker, and microphone.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method comprising:
creating a visual representation of a token;
associating a data structure and data with the token; and
transmitting at least a portion of the data to a receiver in response to a user input associated with the token.

2. The method of claim 1, further comprising:
assigning an identifier to the token; and
associating the identifier with a user account.

3. The method of claim 2, wherein associating the data structure comprises associating at least one of a video, an image, and a text with the token.

4. The method of claim 1, further comprising transmitting at least a portion of the data structure and data to a portable device.

5. The method of claim 2, further comprising:
packaging the token with other tokens in a pack; and
distributing the pack.

6. The method of claim 2, further comprising transferring the token to a second user account in response to a user request.

7. The method of claim 1, further comprising providing additional data to the data structure associated with the token.

8. The method of claim 1, further comprising adding another data structure to the token.

9. The method of claim 8, wherein the adding comprises a user adding the another data structure.

10. The method of claim 1, further comprising providing access to a resource using the token.

11. A method comprising:
choosing a subject matter for a token;
assigning an identity to the token;
creating a visual representation for the token based on the subject matter of the token;
associating a data structure with the token, the data structure storing data;
updating the data stored by the token;
transferring ownership of the token to a user account; and
transmitting at least a portion of the data structure and data to a receiver in response to a user request associated with the token.

12. The method of claim 11, wherein transferring ownership of the token comprises associating the identity with the user account.

13. The method of claim 11, further comprising including access to a resource using the token.

14. The method of claim 11, further comprising:
including the token in a pack with other tokens; and
distributing the pack to the user account.

15. The method of claim 11, wherein associating a data structure with the token comprises associating at least one of a video, an audio clip, an image, and a text with the token.

16. A system, comprising:
a memory configured to store data associated with a token; and
a processor configured to:
create a visual representation of the token;
associate a data structure and data with the token; and
transmit at least a portion of the data to a receiver in response to a user input associated with the token.

17. The system of claim 16, the processor further configured to:
assign an identifier to the token; and
associate the identifier with a user account.

18. The system of claim 17, wherein the processor configured to associate the data structure comprises the processor configured to associate one of a video, an image, and a text with the token.

19. The system of claim 17, the processor further configured to:
package the token with other tokens in a pack; and
distribute the pack.

20. A computer program product embodied in a computer readable medium and comprising computer instructions for:
creating a visual representation of a token;
associating a data structure and data with the token; and
transmitting at least a portion of the data to a receiver in response to a user input associated with the token.

21. The computer program product of claim 20, the computer instructions further comprising:
assigning an identifier to the token; and
associating the identifier with a user account.

22. The computer program product of claim 21, wherein associating the data structure comprises associating one of a video, an image, and a text with the token.

23. The computer program product of claim 21, the computer instructions further comprising:
packaging the token with other tokens in a pack; and
distributing the pack.
